(19) United States
(12) Patent Application Publication
(10) Pub. No.: US 2014/0338410 A1
(43) Pub. Date: Nov. 20, 2014

(54) NON-NUMERIC, NON-TEXTUAL, COLOR-CODED COMBINATION LOCKING DEVICES AND METHODS

(71) Applicant: Yingyen LEE, Port Washington, NY (US)

(72) Inventor: Yingyen LEE, Port Washington, NY (US)

(21) Appl. No.: 13/893,403

(22) Filed: May 14, 2013

(51) Int. Cl. E05B 37/00

(52) U.S. Cl. CPC E05B 37/0072
USPC 70/332

(57) ABSTRACT

A non-numeric, non-textual, color-coded combination locking device has a body, a locking mechanism, and a plurality of dial wheels with colors indicia as identifying members. The wheels rotate relative to the body and locking mechanism and display a plurality of colors across the device. The wheels and the color indicia are configured to simultaneously display colors across the device. The design provides users a different way to remember the unlocking codes in colors instead of numbers and/or letters.

### BACKGROUND OF THE INVENTION

1. Field of the Invention

The present invention relates to combination locking devices having a pre-selection of color-coded combinations, which facilitate a different and easier method for remembering the unlocking code combination. The invention also relates to a method of manufacturing whereby wheels with numbers and/or letters indicia are eliminated and color-coded wheels are used instead.

2. The Prior Art

Locks are widely used in commercial, residential, and institutional environments to protect against theft, unauthorized use, vandalism, sabotage and harm. Locks may be separate-portable (which are called padlocks) or built-in devices, and are commonly used for securing a wide variety objects, including lockers, luggage, bags, doors, gates, containers, bicycles, vehicles and the like.

Locks come in two types, key-based and key-less. A physical key is required to unlock a key-based lock; a combination input is required to unlock a key-less combination-based lock.

Due to the reason that a physical key is required to open the key-based lock, there are risks of lost, stolen or copied keys that can prevent access to the locked item by the authorized user. In addition, a user typically cannot reset or change the key configuration without also replacing a key-based lock. Keyless combination locks overcome the disadvantages of key-based locks by providing a combination code comprised of numbers and/or letters instead of a physical key to unlock.

Two common types of keyless combination locks include single-dial (also known as rotary-style) and multiple-dial (also known as tumbler-style) designs. Single-dial locks generally have a rotating dial that displays a range of numbers and/or letters, while multiple-dial locks generally have three or more tumblers or wheels displaying the numbers 0-9 and/or different alphabet letters. However, these combination-based locks also have some disadvantages. For example, an authorized combination may be forgotten or changed, preventing access to the locked item by the authorized user(s). If the combination is forgotten, the user typically has to destroy the lock to open and remove the lock, which can be inconvenient and costly. Further, the combination to open the lock is usually preset by the manufacturer of the locks, and a user is forced to learn an unrelated or random numeric and/or letter sequence that may be difficult to remember. Even if a user may reset or customize the combination, many users may still have trouble remembering numeric and/or letter combinations. For users whose native languages are not A-Z alphabetically based, remembering the letter or word combination may also be challenging.

### SUMMARY OF THE INVENTION

The unique non-numeric, non-textual, color-coded combination lock which is described herein, addresses many of the disadvantages of numeric and/or letter combination locks by providing a customizable combination lock using colors for the combination that opens the lock. Research and findings show that colors help us to process and store images more efficiently and to remember them better. For example, if a user sets the combination according to an image of a traffic light, he/she will remember the three-color combination which is red-yellow-green. The color combination on the present locking device is easier for the user to remember, and thus more user-friendly than numeric and/or letter combinations. Further, the viewing of the locking device with color indicia on the rotatable dials is natural and can visually blend into any design of luggage, briefcase or the like.

The primary object of the invention of a non-numeric, non textual, color-coded combination lock is to provide a different and more user-friendly combination lock which can overcome the challenges and limitations of prior combination locks. A brief summary of several embodiments and aspects of the invention are presented herein. Thereafter, the advantages or improved results furnished by the invention will be apparent from the following detailed description of an illustrated and preferred embodiment of the invention, which will permit one skilled in the relevant art to understand, make and use the invention.

In one embodiment of the invention, a color-coded combination locking device is provided that comprises a body and a locking mechanism operatively coupled to the body. A plurality of wheels are operatively coupled to the locking mechanism and to the locking device body. Each of the wheels has a plurality of pre-selected colors disposed on face plates around a perimeter of each wheel, that can be arranged to form a combination. The wheels are rotatable relative to the locking mechanism in a locked and unlocked position. The wheels engage the locking mechanism so that in the locked position, the locking mechanism cannot be removed from the wheels, and in the unlocked position, the locking mechanism is released. The unlocked position can only be achieved with a single combination of wheel positions, as set by the user. All other combinations will result in the locking mechanism remaining locked. The specific engagement of the locking mechanism with the wheels will not be discussed in detail here, as the operation of such locks is well known in the art.

In another embodiment, a method of manufacturing a color-coded combination locking device comprises pre-selecting a plurality colors to be displayed by the device, and eliminating manufacturing the rotatable wheels with numeric and/or letters indicia. The method further includes replacing the numeric and/or letters wheels by installing rotatable wheels with a plurality of pre-selected color displayed on each wheel. The method can start with a conventional lock, where the numeric or letter wheels are removed and replaced with colored wheels, or can be a brand mew manufactured lock, where the colored wheels are initially installed in the body of the lock.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIGS. 1A and 1B show the customizable non-numeric, non-textual, color-coded locking device in accordance with an embodiment of the invention, in a locked and unlocked state;

FIG. 2 shows one of the locking wheels used in the locking device according to the invention;

FIG. 3 is a block diagram of a representative table illustrating pre-selection of colors and positions of the wheels in accordance with embodiments of the invention;

FIGS. 4A-4C are each a view of the locking device in accordance with other embodiments of the invention; and

FIGS. 5A and 5B are views of the locking devices in accordance with other embodiments of the invention.

### DETAILED DESCRIPTION OF THE PREFERRED EMBODIMENT

The present invention will be described more fully hereinafter with reference to the accompanying drawings, in which some examples of the embodiments of the inventions are shown. These inventions may be embodied in many different forms and should not be construed as limited to the embodiments set forth herein; rather, these embodiments are provided by way of example so that this disclosure will satisfy applicable legal requirements. Non-textual, non-numeric color-coded combination locks include but are not limited to locks for securing lockers, toolboxes, luggage, briefcases, bags, gates, doors, containers, bicycles, vehicles and the like. In the following description, numerous specific details are discussed to provide a thorough and enabling description for embodiments of the invention. One skilled in the relevant art, however, will recognize that the invention can be practiced without one or more of the specific details. In other instances, well-known structures or operations are not shown, or are not described in detail to avoid obscuring aspects of this invention. In general, alternatives and alternate embodiments described herein are substantially similar to the previously described embodiments, and common elements are identified by the same reference numbers.

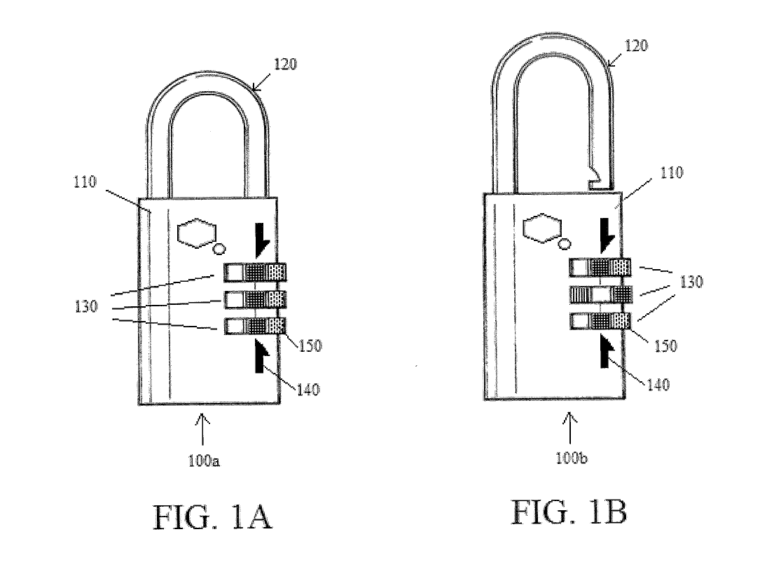

FIGS. 1a and 1b show one embodiment of the non-textual, non-numeric color-coded combination locking device 100 in accordance with at least one embodiment of the invention. The device 100 may be in locked (100a) or unlocked (100b) positions, and includes tumblers or wheels 130 displaying colors configured to simultaneously display three colors in a row when the locking device is in the locked or unlocked positions. In one embodiment, the locking device 100 includes a body 110, a locking mechanism 120 and three rotatable wheels 130. The body 110 houses the internal lock components (not shown) of the locking device 100. The locking member 120 is operatively coupled to the body 110 such that the locking member 120 can move between a locked position with incorrect combination in 100a, and an unlocked position with correct combination 100b. In the locked position, the locking member 120 is securely engaged by the internal lock components in a conventional manner. The locking member 120 remains securely engaged with the internal lock components until a user manipulates the wheels 130 to a predetermined correct combination, thereby allowing the locking member 120 to move to the unlocked position. In the unlocked position 100b, the locking member 120 is spaced apart from the body 110 to allow a user to attach the locking device 100 to other objects.

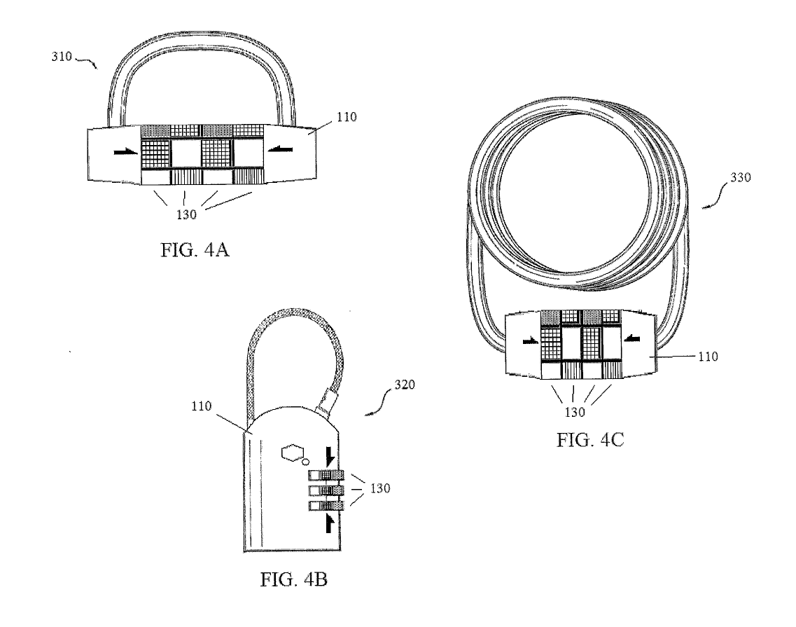

The locking member 120 can be rigid or flexible. For example, as shown in FIG. 4A, the locking member 120 may be formed of a single rigid piece of metal, such as hardened steel. In other embodiments such as shown in FIGS. 4B and 4C, the locking member 120 can be a flexible wire or cable, respectively, that does not retain a predetermined shape in order to accommodate larger or odd sized objects, such as a bicycle or a gate for examples.

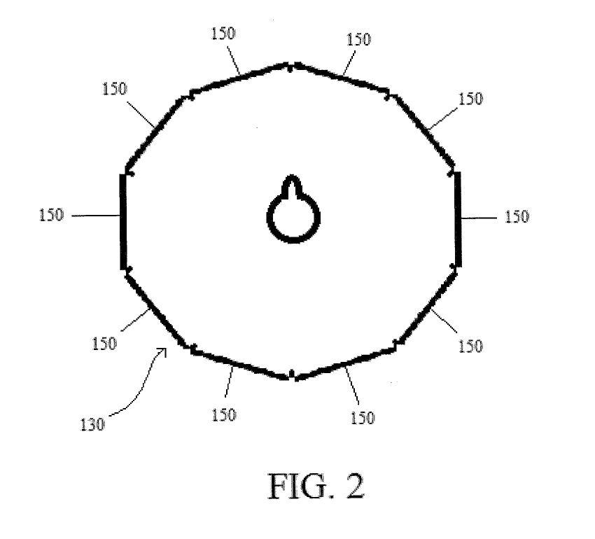

The body 110 may also include a combination position indicator 140 proximate to the wheels 130. The indicator 140 of the illustrated embodiment is positioned approximately in the middle portion of the body 110 to indicate where the lock combination will be displayed by the wheels 130. In certain embodiments, the indicator 140 identifies to a user where to position the wheels 130 that have selected colors that correspond to the combination of the locking device 100. When the correct combination of the colors is positioned in alignment with the indicator 140, the locking member 120 can freely move between the locked and unlocked positions. The wheels 130 of the illustrated embodiment are axially aligned with each other and with the body 110. Each of the wheels 130 includes a plurality of pre-selected colors on face plates 150 positioned around the wheel 130. The wheels 130 of the illustrated embodiment each have ten face plates 150 with different colors evenly spaced around the circumference of the wheel, as shown in FIG. 2. Other embodiments can have greater or fewer face plates 150 or more wheels 130.

In at least one embodiment, the lock device 100 is configured so the user can set or reset the combination of the lock device to unlock the device. The user can simply set or reset the lock's combination arrangement to be his or her favorite colors, or according to a colored image that is related to the usage of the lock that is easy to remember. For example, the arrangement of combination of a travel lock can be reset according to an image of a foreign country's flag, like Italy (green-white-red), Germany (black-red-yellow), and France (blue-white-red). In another example, the arrangement of combination of a bike lock can be reset according to an image of a traffic light (red-yellow-green) or crosswalk (black-white-black). While the above examples provide sample combinations that can be used for different categories of locks, one skilled in the art will understand that other combinations can be used for a selected device. Various mechanisms for resetting a combination lock are available and known in the art. Accordingly, the resettable combination is an important feature of the non-textual, non-numeric, color-coded locking device that allows the user to remember the correct combination easier.

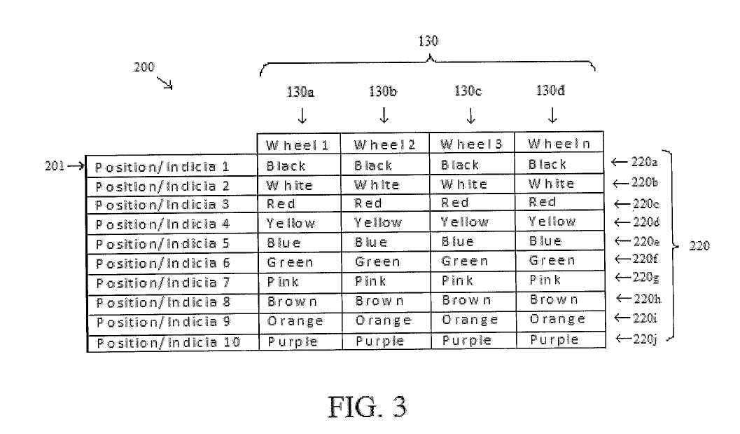

FIG. 3 is a block diagram of a representative table 200 illustrating colors or indicia of the wheels 130 in accordance with several embodiments of the invention. In one embodiment, the table 200 illustrates a locking device having at least three wheels 130 as shown by the wheel columns 130a-130d. Each wheel 130 has a plurality of color positions 1-10 for displaying one color in each face plate 150. Aligning the color positions 1-10 on face plates 150 of the wheels 130 simultaneously displays the colors in a plurality of rows 220 (220a-220j). In another embodiment, the colors are a selection of six elementary colors (black, white, green, red, blue and yellow) and four other commonly used colors (pink, brown, orange and purple).

In still another embodiment illustrated in FIG. 3 as indicated above, the combination lock may have more than three wheels, as illustrated as Wheel n. For a three wheel combination lock, each wheel rotates independently of the others, yielding possible 10³ (or 1,000) different combinations. For a combination lock with n wheels, there are 10ⁿ possible different combinations. A greater number of wheels can in turn increase security because of the greater number of combinations to open the locking device.

FIGS. 4A to 4C are schematic views of the non-numeric, non-textual, color-based combination locking device in accordance with other embodiments of the invention. FIG. 4A illustrates the locking device 310 having a locking member that is made of steel. FIG. 4B illustrates the locking device 320 having a locking member that is a flexible wire. FIG. 4C illustrate the locking device 330 having a locking member that is a flexible cable. In all of FIGS. 4A to 4C, similar reference characters are used to indicate similar features of the embodiments and will not be repeated.

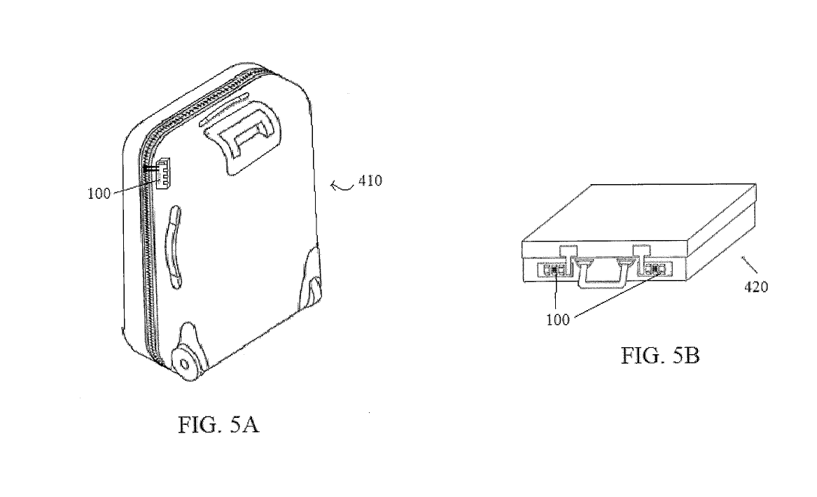

FIGS. 5A and 5B are schematic views of present invention built-in and integrated into luggage 410 and briefcase 420. Another optional aspect of the present invention is that the non-numeric, non-textual, color-coded combination lock 100 can be integrated into products such like luggage 410 and briefcase 420. FIGS. 5A and 5B illustrate two examples that numerous modifications, including, but not limited to, variations in size, materials, shape, form, function and manner of operation, assembly and use, may be made without departing from the principles and concepts of the present invention.

From the foregoing, it will be appreciated that specific embodiments of the invention have been described herein for purposed of illustration, but that it is also to be understood that the inventions are not to be limited to the specific examples of the embodiments disclosed and that various modifications may be made without deviating from the scope of the invention. Although specific terms are employed herein, they are used in a generic and descriptive sense only and not for purposes of limitation. Those skilled in the art may readily adopt one or more of the inventive aspects, features or concepts into other or additional embodiments and uses within the scope of the present inventions even if such embodiments are not expressly disclosed herein.

What is claimed is:

1. A locking device comprising:
a body;
a locking mechanism operatively coupled to the body; and
a plurality of wheels operatively coupled to the locking mechanism and to the body, each of the wheels being rotatable relative to the body between a locked position wherein the locking mechanism is locked relative to the respective wheel, and an unlocked position wherein the locking mechanism is unlocked relative to the respective wheel,
wherein each wheel displays a plurality of colors to form a plurality of color codes relative to the body, and
wherein in the unlocked position, the wheels are arranged in a specific unlocking combination displaying a preset color code.

2. The locking device of claim 1, wherein the wheels do not display any numbers or letters.

3. The device of claim 1, wherein the colors displayed on the wheel are a selection of predetermined colors.

4. The device of claim 3, wherein the colors on each wheel include black, white, green, red, blue and yellow.

5. The device of claim 3, wherein the colors on each wheel additionally include at least four other colors.

6. The device of claim 1, wherein the locking combination is resettable.

7. A method of manufacturing a locking device, comprising the following steps:
selecting a plurality of colors to be displayed by the device;
placing the colors on a plurality of rotatable wheels such that each wheel displays each of the selected color along face plates disposed around a perimeter of each wheel;
arranging the wheels in a body of the locking device so as to interact with a locking mechanism connected to the body; and
configuring an unlocking combination of the locking mechanism based on the arrangement of the wheels in the body.

8. The method according to claim 7, wherein ten different colors are placed on each wheel.

9. A method of manufacturing a locking device, comprising the following steps:
selecting a locking device having a plurality of wheels containing numbers or letters;
removing the wheels from a body of the locking device;
selecting a plurality of colors to be displayed by the device;
placing the colors on a plurality of rotatable wheels such that each wheel displays each of the selected color along face plates disposed around a perimeter of each wheel;
arranging the wheels in the body of the locking device so as to interact with a locking mechanism connected to the body; and
configuring an unlocking combination of the locking mechanism based on the arrangement of the wheels in the body.
